(19) United States
(12) Patent Application Publication
(10) Pub. No.: US 2026/0197666 A1
(43) Pub. Date: Jul. 9, 2026

(54) REPEATER CONTROL METHOD AND RELATED APPARATUS

(71) Applicant: Morelink Technology Corporation, Taipei City (TW)

(72) Inventors: Yung-ting Lee, Taipei City (TW); Chunn-yenn Lin, Taipei City (TW)

(73) Assignee: Morelink Technology Corporation, Taipei City (TW)

(21) Appl. No.: 19/441,879

(22) Filed: Jan. 7, 2026

Related U.S. Application Data
(60) Provisional application No. 63/742,875, filed on Jan. 8, 2025.

(51) Int. Cl. H04W 16/18; H04W 24/10; H04W 64/00

(52) U.S. Cl. CPC H04W 16/18; H04W 24/10; H04W 64/00

(57) ABSTRACT

A repeater control method and relevant apparatus is disclosed. In this application, a network controller determines whether an area requires a repeater to enhance communication performance and, when required, determines at least one operating parameter including a target location. The network controller transmits a network command carrying the target location to a hosting platform on which the repeater is mounted, thereby causing the hosting platform to move to the target location. Accordingly, repeater deployment is dynamically adjustable to satisfy temporary and time-sensitive coverage and/or service quality requirements in wireless networks.

### CROSS REFERENCE TO RELATED APPLICATION

This application claims the benefit of U.S. Provisional Application No. 63/742,875, filed January 8, 2025. The entire disclosure of this application is incorporated herein by reference.

### TECHNICAL FIELD

The present application relates to wireless communication technologies, and more particularly to a repeater control method and related apparatus.

### BACKGROUND

In wireless communication systems, signals are exchanged between a base station (e.g., a cell tower, or gNB in 5G NR (New Radio)) and one or more mobile terminals or user equipments (UEs). The base station can provide services within a coverage area, which may be expanded by a use of repeaters. The repeaters can improve the quality of wireless communication by receiving, filtering, amplifying and re-transmitting the signals communicated between the base station and the one or more UEs in both an uplink (UL) direction (i.e., from the UE to the base station) and a downlink (DL) direction (i.e., from the base station to the UE).

The installation of traditional repeaters needs to be planned in advance. Technicians need to go to the site to conduct measurements first, formulate deployment plans, and then deploy, debug and maintain. This standard of operation (SOP) has been widely adopted over the past many years and does solve the coverage issues. However, as application scenarios and user behaviors become increasingly diversified, the traditional repeater deployment SOP cannot meet the temporary and urgent coverage or quality requirements in wireless networks.

### SUMMARY

An objective of the present application is to provide a repeater control method, a network controller and a movable device, for enhancing communication performance (e.g., system capacity, coverage or spectrum efficiency) in temporary and time-sensitive application scenarios.

In a first aspect, the present application provides a repeater control method, performed by a network controller, including determining whether an area requires a repeater to enhance communication performance; if the area requires the repeater to be deployed, determining at least one operating parameter for the repeater, wherein the at least one operating parameter includes a target location; and transmitting a network command with the target location to a hosting platform with the repeater mounted thereon to request the hosting platform to move to the target location.

In a second aspect, the present application provides a network controller, including a memory, storing instructions; and a processor coupled to the memory, configured to execute the instructions stored in the memory to perform the method according to the first aspect.

In a third aspect, the present applicant provides a movable device, including a repeater, configured to amplify and forward radio signals between a base station and at least one user equipment (UE) and; a hosting platform, with the repeater mounted thereon, configured to receive from a network controller a network command conveying a target location determined for the repeater to move the repeater to the target location.

Compared with conventional repeater deployment practices, the embodiments of the present application enables the network controller to determine whether an area requires a repeater to enhance communication performance and, when needed, to determine at least one operating parameter including a target location. By transmitting a network command carrying the target location to a hosting platform on which the repeater is mounted, the hosting platform is caused to move to the target location. Accordingly, the repeater deployment can be adjusted in a timely and flexible manner to address temporary and urgent coverage or quality requirements in wireless networks.

### BRIEF DESCRIPTION OF THE DRAWINGS

FIG. 1 illustrates an example communication environment according to some embodiment of the present application.

FIG. 2 is a block diagram illustrating an analog FDD repeater according to some embodiments of the present application.

FIG. 3 is a block diagram illustrating a digital FDD repeater according to some embodiments of the present application.

FIG. 4 is a flowchart of a repeater control method according to some embodiments of the present application.

### DETAILED DESCRIPTION

In this document, a combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

The embodiments of the present application enable a repeater to be deployed in a timely and flexible manner to enhance communication performance (e.g., system capacity, coverage or spectrum efficiency) to meet temporary and time-sensitive coverage and/or service-quality requirements.

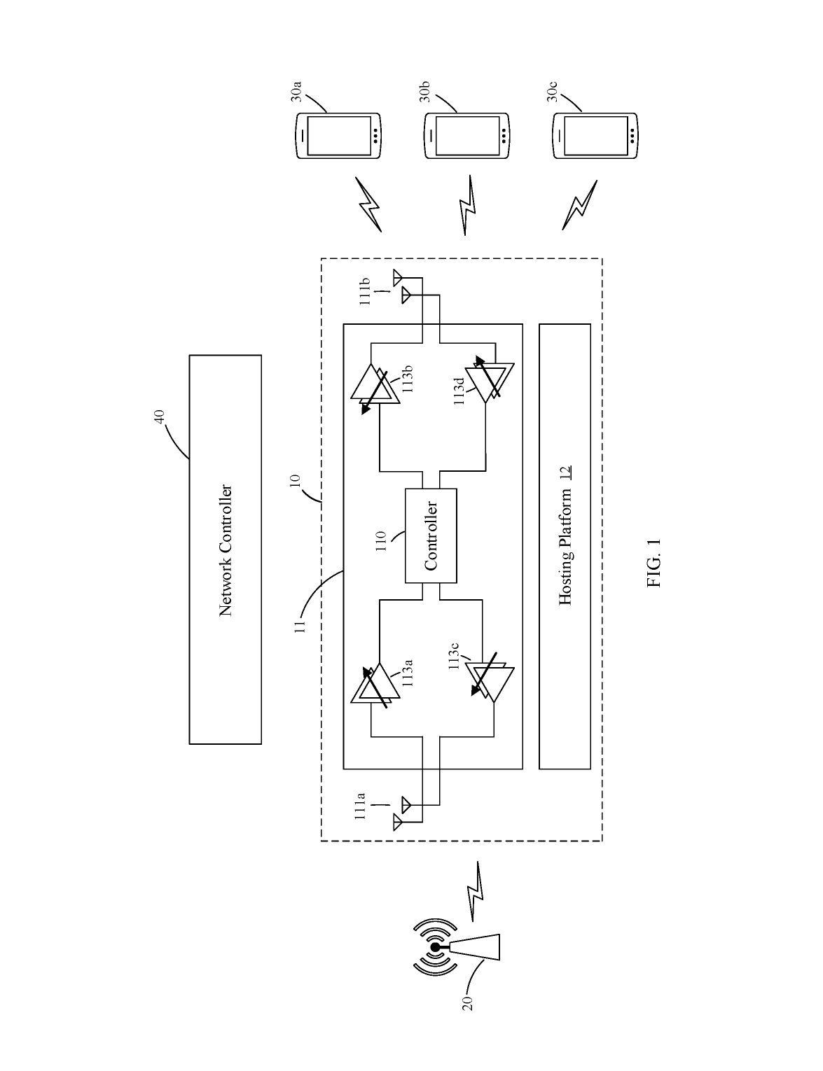

FIG. 1 illustrates an example communication environment. In the environment, there is a movable device 10 carrying a repeater 11. There also has a base station 20, a plurality of user equipments (UEs) 30a-30c, and a network controller 40. In the illustrated embodiment, the network controller 40 is configured to manage or coordinate deployment of the repeater 11. The movable device 10 includes a hosting platform 12 configured to transport the repeater 11 to a target location designated by the network controller 40. The hosting platform 12 may be implemented by, for example, an unmanned aerial vehicle (UAV), a ground vehicle, a driverless car, a robot, or any movable carrier capable of repositioning the repeater 11.

In the illustrated embodiment, the repeater 11 is arranged to amplify and forward radio signals between the base station 20 and the UEs 30a-30c. The repeater 11 may include one or more antennas 111a and 111b to support signal reception and transmission. The repeater 11 may further include a controller 110 and one or more radio-frequency (RF) processing components 113a-113d, such as amplifiers, for uplink and downlink forwarding paths. The RF processing components 113a and 113b may be used for downlink signals from the base station 20 to the UEs 30a-30c, while the RF processing components 113c and 113d may be used for uplink signals from the UEs 30a-30c to the base station 20. The controller 110 may be configured to control the gain of the amplifiers or beam pattern based on operating parameters received from the network controller 40.

The base station 20 can be, for example, an eNB (or eNodeB) in Long Term Evolution (LTE), or a gNB (or gNodeB) in New Radio (NR), or any network device in future mobile network. The UEs 30a-30c may be terminal devices in a radio access network (RAN) and would be implemented by wireless terminals, user terminals, mobile terminals (MT), and etc. The network controller 40 can be a function, a chip, a circuit, a physical module or an equipment in the radio network. The network controller 40 may be integrated to any network function (NF) in a core network (CN) or may be mounted on a server that one or more NFs in the core network can communicate therewith. It is noted that the repeater 11 may serve more than one user equipments 30a-30c and may repeat signals from one or more base stations 20 and transmit repeated signals to the one or more base stations 20.

In operation, the network controller 40 may determine whether a particular area requires deployment or repositioning of the repeater 11 to enhance communication performance. Such determination may be based on network-side information, for example, base station deployment, UE distribution, traffic distribution information, quality-of-service (QoS) indicators, coverage hole indications, measurement reports from the UEs 30a-30c, the repeater 11 and/or the base station 20, or other network performance metrics. When the network controller 40 determines that the area requires repeater assistance, the network controller 40 may determine at least one operating parameter for the repeater 11, wherein the operating parameter includes a target location at which the repeater 11 is expected to provide improved communication performance such as better coverage or spectrum efficiency. In addition to the target location, the operating parameter may further include orientation, altitude, antenna beam pattern, gain, and power of the repeater, and so on.

After determining the target location, the network controller 40 transmits a network command conveying the target location to the hosting platform 12 with the repeater 11 mounted thereon. The network command carrying the at least one operating parameter may be transmitted via in-system signaling over a same radio system supported by the repeater 11 or via out-of-system signaling over a radio system different from the radio system supported by the repeater 11. The network command may be delivered via a wireless control interface supported by the hosting platform 12. Upon receiving the network command, the hosting platform 12 is caused to move the repeater 11 toward the target location. In some implementations, the hosting platform 12 may provide status feedback to the network controller 40, such as an acknowledgement of the command, estimated arrival time, or confirmation of arrival.

Once the hosting platform 12 positions the repeater 11 at or near the target location, the repeater 11 operates to amplify and forward radio signals between the base station 20 and the UEs 30a-30c, thereby improving communication performance in the identified area.

Accordingly, compared with conventional repeater deployment practices, the embodiments described herein enable the network controller 40 to determine whether an area requires a repeater to enhance communication performance and, when needed, to determine an operating parameter including a target location. By transmitting a network command carrying the target location to the hosting platform 12 on which the repeater 11 is mounted, the hosting platform 12 can be directed to move to the target location. As a result, the repeater deployment can be adjusted in a timely and flexible manner to address temporary or time-sensitive coverage and/or quality requirements in wireless networks.

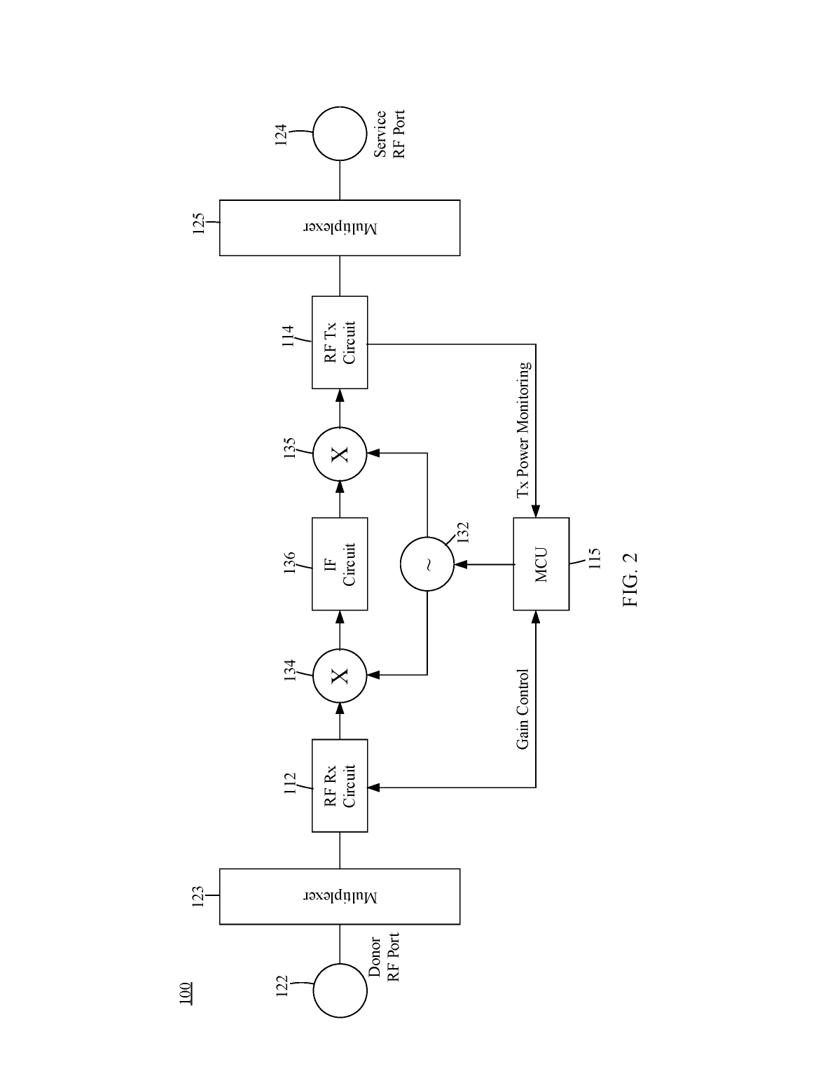

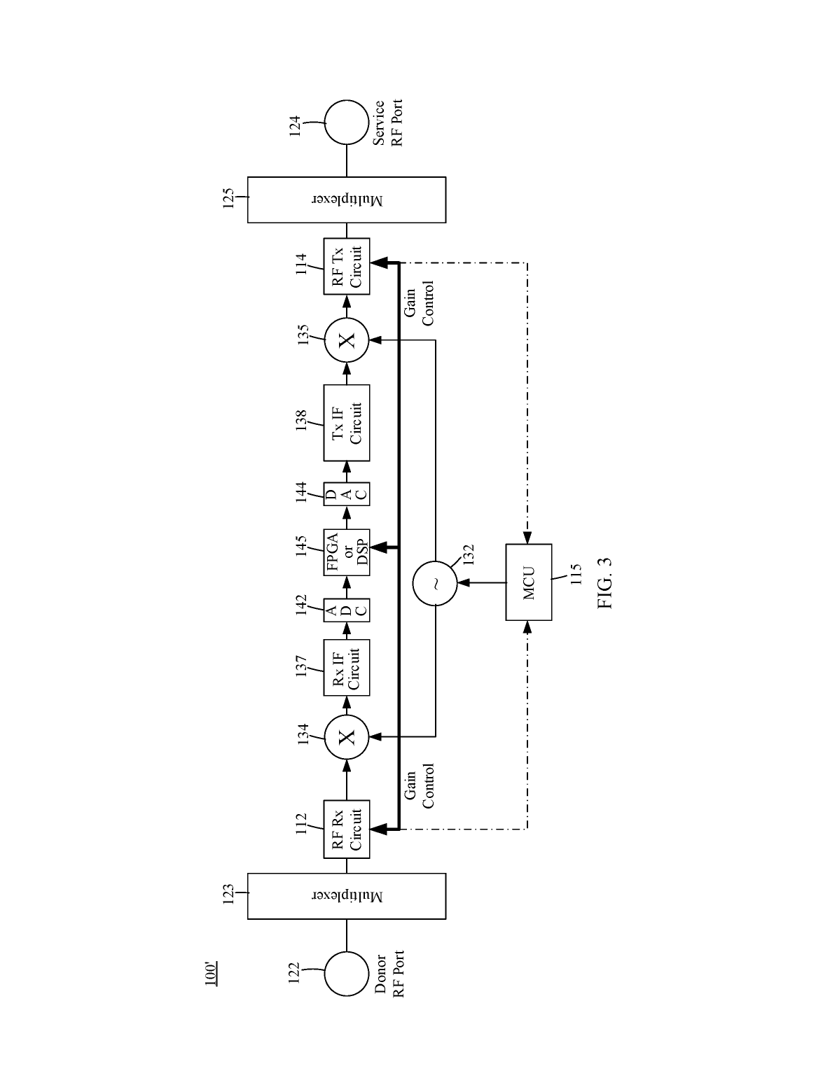

FIG. 2 illustrates an analog frequency division duplex (FDD) repeater 100, while FIG. 3 illustrates a digital FDD repeater 100’. The invention can be implemented not only by the analog FDD repeater 100 and the digital FDD repeater 100’ illustrated in FIG. 2 and FIG. 3 respectively, but also by other types of repeaters, such as an analog or digital time division duplex (TDD) repeater, a hybrid repeater with mixed analog and digital circuits, and so on. It should be noted that the repeaters shown in FIG. 2 and FIG. 3 are illustrated exemplarily in a DL configuration; however, it is straightforward to derive a UL configuration for the repeaters. As a result, the UL configuration is omitted for simplicity of description.

As shown in FIG. 2 and FIG. 3, the repeater 100, 100’ includes a RF Rx circuit 112, an RF Tx circuit 114 and a microcontroller (MCU) 115. In one circuit configuration, for DL signals, the RF Rx circuit 112 may be coupled to a donor RF port 122 (via a multiplexer 123) which is used to connect to a donor antenna (not shown) for receiving downlink signals from the base station, and the RF Tx circuit 114 may be coupled to a service RF port 124 (via a multiplexer 125) which is used to connect to a service antenna (not shown) for transmitting the downlink signals to the user equipment. In another circuit configuration, for UL signals, the RF Rx circuit 112 may be coupled to the service antenna for receiving uplink signals from the user equipment, and the RF Tx circuit 114 may be coupled to the donor antenna for transmitting the uplink signals to the base station. One of various functions of the MCU 115 is to perform gain control of the RF Rx circuit 112 and the RF Tx circuit 114.

As depicted in FIGS. 2 and 3, the repeater 100, 100’ further includes a local oscillator 132, two mixers (i.e., mixer 134 and mixer 135), and an intermediate frequency (IF) circuit 136 (or in case of the digital repeater 100’, RX IF circuit 137 and TX IF circuit 138). The LO 132 serves as an electronic signal source that generates a stable waveform at a specific frequency for assisting frequency up-conversion and down-conversion in the repeater 100, 100’. The mixer 134 produces a signal with a down-converted frequency based on mixing of a local oscillation frequency generated by the LO 132 with an incoming RF signal. The IF circuit 136 (or in case of the digital repeater 100’, RX IF circuit 137 and TX IF circuit 138) can process the lower IF signal or may be replaced by a baseband circuit that process the baseband signal. The mixer 135 produces a signal with an up-converted frequency based on mixing of the LO frequency with the signal from the IF circuit 136. Different from the analog repeater 100 depicted in FIG. 2, the digital repeater 100’ depicted in FIG. 3 includes an analog- to-digital circuit (ADC) 142, a digital-to-analog circuit (DAC) 144, and a field programmable gate array (FPGA) or digital signal processor (DSP) chip 145 located between the ADC 142 and the DAC 144. The digital repeater 100’ performs digital signal processing by using the afore-mentioned circuit elements.

The repeater may be provided with at least one of mobility capability, network controllability, and data collection and analysis capabilities. The repeater installed on, integrated with, or implemented within the hosting platform may be implemented as a function, a chip, a circuit, or a physical module disposed in the hosting platform.

In some embodiments, the hosting platform is configured to transport the repeater to a target location. The target location can be represented through GNSS coordinate or any proximity positioning methods. The hosting platform may be configured to report location information back to the network controller, and the movement of the hosting platform can be arranged by the network controller via one or more network commands. The exact location of the repeater under repeating can be controlled by the network controller and/or by repeater itself to optimize communication performance (e.g., wireless system capacity) based on the information of at least one of the following:

i. Received SNR (Signal-to-Noise Ratio) and strength of the serving base station, where higher SNR and/or strength is preferred.

ii. Radio channel conditions between the repeaters, the base stations, and the UEs, where line-of-sight (LOS) is preferred with minimal effects of terrain and physical obstructions.

iii. Mutual interference between the repeaters, in which it can be judged by the distance, antenna orientation, target coverage areas and so on among the repeaters.

iv. Occurring or predicted temporary and/or urgent traffic load requirements in a pre-planned activity such as a concert.

In some embodiments, the hosting platform is further configured to adjust orientation and/or altitude of the repeater. The hosting platform may be able to adjust and maintain the orientation and altitude by integrating gyroscopes, compasses, altimeters, and so on. The hosting platform may be able to reply its orientation and altitude information back to the network controller. The adjustments of the orientation and/or altitude may be mainly achieved through network commands by considering at least one of the following:

i. The orientation and altitude of the serving base station.

ii. The orientation and altitude of the coverage area.

iii. The traffic load of the serving base stations and the neighboring base stations. It may also have to avoid the signals from high-loaded neighboring cell.

iv. The radio channel condition of UE’s area, where line-of-sight (LOS) is preferred with minimal effects of terrain and physical obstructions.

v. The radio channel condition of the repeater’s current position, such as indoor to indoor, outdoor to outdoor, outdoor to indoor, and indoor to outdoor, in order to minimize the total penetration loss and propagation loss.

vi. The mutual interference between the repeaters, in which it can be judged by the distance, antenna orientation, target coverage areas and so on among the repeaters.

vii. The interference of the repeater on the base station in order to prevent the base station from receiving unexpected high power due to repeater gain control errors.

viii. The hardware status of the repeater (e.g., max/min gain, max output power, antenna beampattern and direction, and so on), electric power (battery or AC to maintain the orientation and altitude), and so on.

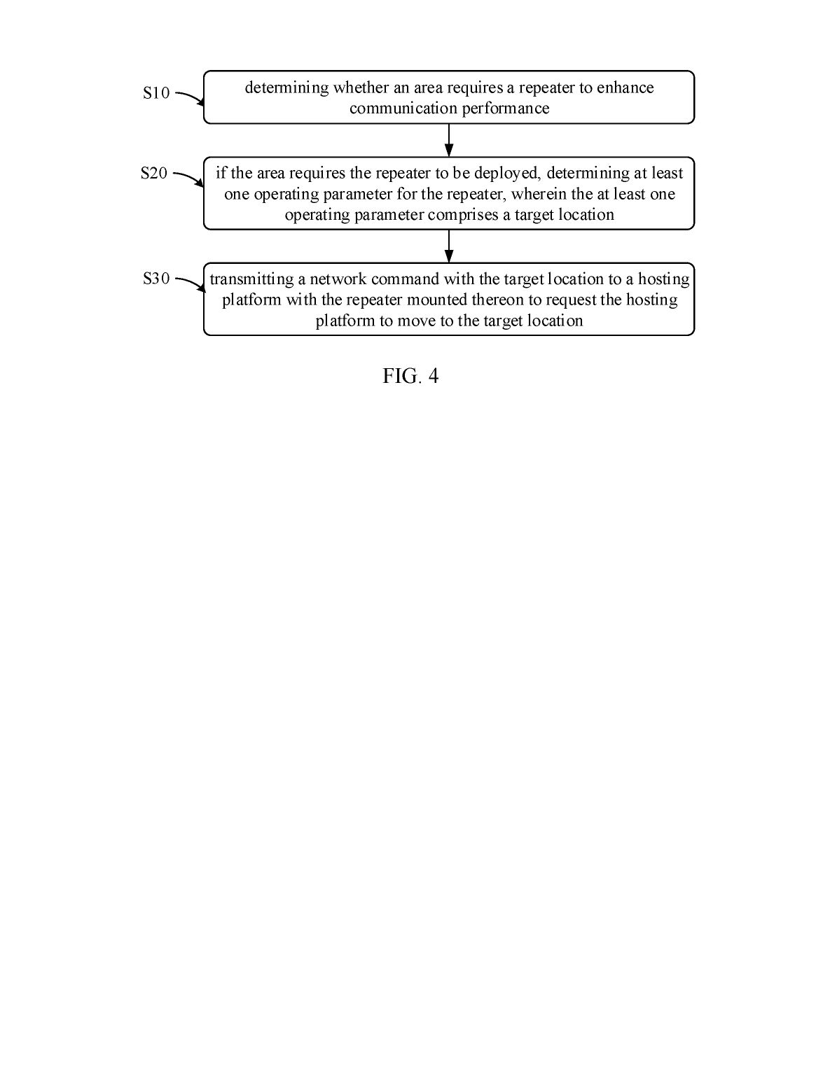

FIG. 4 is a flowchart of a repeater control method according to some embodiments of the present application. The repeater control method is performed by the network controller. The control purpose is mainly to improve communication performance (e.g., coverage or spectrum efficiency) and may solve temporary overload requirements and load balancing issues. It should be noted that, as an exemplary example, the following describes the repeater control process for temporary coverage requirements. During the process, decisions and/or predictions are made by considering base station deployment, UE distribution, local system (e.g., base station, backhaul system) capacity requirements, required coverage area, network measurements, repeater measurement reports, and/or other conditions. The repeater control method includes the following steps.

In Step S10, the network controller determines whether an area requires a repeater to enhance communication performance.

Such determination may be based on various network information. For example, based on the changes in the number of active and idle UEs, as well as changes in QoS and/or the number of connections for UE dedicated connections, the network controller may determine whether an area requires repeater(s) to enhance communication performance, or more particularly, identify which areas require repeater(s) to enhance coverage and/or spectrum efficiency. It may be determined by the (pre-planned) expected results and network management reports from base stations. In addition, it also allows manual configuration of areas within the network controller to meet temporary coverage and/or spectrum efficiency enhancement requirements.

In Step S20, if the area requires the repeater to be deployed, the network controller determines at least one operating parameter for the repeater, wherein the at least one operating parameter includes a target location.

When the network controller determines that the area requires repeater assistance, the network controller determines at least one operating parameter for the repeater to operate at. At the target location, the repeater is expected to provide improved communication performance. In addition to the target location, the operating parameter may further include orientation, altitude, antenna beam pattern, gain, and power of the repeater, and so on.

In some embodiments, for an area requires repeater(s) to enhance communication performance, the network controller may determine candidate base stations suitable for the temporary demands through the proximity relationship between active base stations, available repeater in service, and coverage areas. The active base stations surrounds the target area. Note that it is best if two candidate base stations are located as far apart as possible geographically. Typically, one repeater is used for one candidate base station. However, one base station may serve multiple repeaters.

In some embodiments, based on the current traffic load of the candidate base stations and the expected growth of the traffic load, the network controller may select base stations to serve the repeaters from the candidate base stations and the corresponding repeaters for the temporary coverage and/or spectrum efficiency enhancements. The selected repeaters are also called serving repeaters. A candidate base station may be selected as a serving one based on its current load and expected load during the required time period. Basically, there are the following criteria: i. the larger the expected load or the current load is, the larger chance the base station is selected. ii. when expected load is greater than a certain threshold, say 85%, because it needs to reserve some bandwidth for handover requirements. Besides, multiple repeaters may be selected as serving ones for each serving base station. In addition, the expected location, orientation, altitude, (maximum) gain and (maximum power) of these serving repeaters may also be determined by the network controller at this stage.

In Step S30, the network controller transmits a network command with the target location to a hosting platform with the repeater mounted thereon to request the hosting platform to move to the target location.

After determining the target location, the network controller transmits a network command conveying the target location to the hosting platform with the repeater mounted thereon. Upon receiving the network command, the hosting platform is caused to move the repeater toward the target location. The network command may be transmitted via in-system signaling over a same radio system supported by the repeater or via out-of-system signaling over a radio system different from the radio system supported by the repeater.

In some embodiments, the network command also conveys at least one of orientation, altitude, antenna beam pattern, gain, and power of the repeater. The network controller notifies each serving repeater of its expected location, orientation, altitude and/or antenna beam pattern, but not limited thereto, through relevant network commands. These commands can be sent to the serving repeaters via broadcast, multicast, or unicast.

In some embodiments, after receiving the network commands, the hosting platform will start moving to the destination. Upon arrival, the hosting platform begins to find its optimized position and its orientation altitude, and/or antenna beam pattern as required by network commands and/or the repeater itself. When the hosting platform cannot accurately reach or maintain the expected destination, the expected orientation, the expected altitude, and/or the expected radio channel condition, the hosting platform will try to get as close as possible to the expected target (location, orientation, altitude) by the repeater itself, and then report the situation back to the network controller. Therefore, the network controller can decide to accept the situation or request the repeater to move to another target.

In some embodiments, when the repeater reaches the expected target (location, orientation, altitude), the repeater may automatically start, or when requested by the network controller, forwarding radio signals between the serving base station and the UEs in the coverage area. At this moment, the network controller may re-configure the operating parameters of serving base stations, such as new settings for antenna beam pattern, transmit power, and so on, to optimize the desired coverage performance, for example.

In some embodiments, when this temporary demand disappears as determined by the network controller, the network controller will request the serving repeaters to suspend forwarding radio signals, and may further request them to stay in place or move to a new location and request the repeater to stand by until a new temporary demand occurs.

In some embodiments, when the repeater hardware status indicates that it cannot continue to forward radio signals, the repeater may report this status to the network controller and return to or go to the location specified by the network controller and/or the repeater itself.

The repeater may be able to analyze the data that it collects locally, send the collected data back to the network controller for further analysis, or a combination of both. For example, the repeater calculates statistics on the collected data and sends the statistics back to the network controller for further analysis. The collected data include, but are not limited to, the downlink (DL)/uplink (UL) power received by the repeater, the DL/UL power transmitted by the repeater, and the received in-phase and quadrature (I/Q) data captured by the repeater.

The analysis method may be based on artificial intelligence (using AI model such as generative AI model or discriminative AI model), learning through priori information (e.g., deterministic events and current system information), past data (e.g., statistics obtained in the past) or any data collected by repeaters, base stations, and UE, and further providing certain predictions for the future. The purpose of the analysis method is to

i. Optimize network operations through improved spectral efficiency, reduced power consumption and new smart spectrum coordination solutions.

ii. Reduce network operating costs and improve radio resource management through automated processes.

iii. Enhance network performance, provide more reliable and high-quality network performance, and improve user experience.

As for the new smart spectrum coordination, it can reduce the designated spectrum of a base station so that the serving base station could own a clean spectrum for the repeaters. For example, originally, 90MHz is designated to a base station. When the base station only need, say 30MHz, it could reduce its TRx to the 30MHz only. The rest 60MHz becomes clean.

For the analysis method, it can be either generative AI or discriminative AI, as long as it can achieve the above purpose.

On the other hand, a priori information is usually provided by system users about deterministic events (e.g., concerts) or current system information (e.g., changes in the number of dedicated connections and their QoS). The past data include, but are not limited to, statistics data on the number of UEs in the area, the user behavior of throughput and QoS requirements, and the base station traffic load.

In some embodiments, the analysis results based on the artificial intelligence may be applied to determining whether an area requires the repeater to enhance communication performance. Additionally, the analysis results based on the artificial intelligence may be used to generate new configurations for the repeaters, and even serving and neighboring base stations. For the repeaters, the new configurations include, but are limited to, the expected location, orientation, altitude, (maximum) gain and (maximum) power. For base stations, new configurations include, but are not limited to, transmission power adjustment, antenna beam pattern adjustment, radio resource allocation strategies, and so on.

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

It should be understood that any embodiments disclosed herein as being “non-transitory” do not exclude any physical storage medium, but rather exclude only the interpretation that the medium can be construed as a transitory propagating signal.

The elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. A repeater control method, performed by a network controller, comprising:
determining whether an area requires a repeater to enhance communication performance;
if the area requires the repeater to be deployed, determining at least one operating parameter for the repeater, wherein the at least one operating parameter comprises a target location; and
transmitting a network command with the target location to a hosting platform with the repeater mounted thereon to request the hosting platform to move to the target location.

2. The method according to claim 1, wherein the at least one operating parameter further comprises at least one of the following: orientation, altitude, antenna beam pattern, gain, and power of the repeater.

3. The method according to claim 1, wherein the at least one operating parameter is conveyed through the network command, which is transmitted via in-system signaling over a same radio system supported by the repeater.

4. The method according to claim 1, wherein the at least one operating parameter is conveyed through the network command, which is transmitted via out-of-system signaling over a radio system different from the radio system supported by the repeater.

5. The method according to claim 1, wherein whether the area requires the repeater to enhance communication performance is determined based on at least one of the following: base station deployment, user equipment (UE) distribution, local system capacity requirement, required coverage area, network measurement, and repeater measurement report.

6. The method according to claim 1, wherein whether the area requires the repeater to enhance communication performance is determined based on artificial intelligence, learning through priori information, past data or any data collected or deduced by at least one of the repeater, a base station, and a UE.

7. The method according to claim 1, wherein for coverage and/or spectrum efficiency enhancement, whether the area requires the repeater to enhance communication performance is determined based on at least one of the following: a change in a number of UEs in the area, a change in quality-of-service (QoS) level for the UEs in the area, and a number of dedicated UE connections in the area.

8. The method according to claim 1, wherein if the area requires the repeater to be deployed, before determining the at least one operating parameter for the repeater, the method further comprises:
determining candidate base stations based on proximity relationship between active base stations and available repeater(s) in service in the area; and
based on traffic load of the candidate base stations, selecting at least one base station from the candidate base stations and a corresponding repeater served by the selected at least one base station.

9. The method according to claim 1, wherein in determining the at least one operating parameter for the repeater, the at least one operating parameter for the repeater is determined based on artificial intelligence, learning through priori information, past data or any data collected or deduced by at least one of the repeater, a base station, and a UE.

10. The method according to claim 1, wherein after requesting the hosting platform to move to the target location, the method further comprises:
receiving a current location of the repeater; and
deciding to accept the current location of the repeater or requesting the hosting platform to move to another target location.

11. The method according to claim 1, wherein the transmitted network command causes the hosting platform to move to the target location and adjust the repeater’s orientation and altitude as specified by the at least one operating parameter in the network command.

12. The method according to claim 1, wherein when the hosting platform moves the repeater to a desired location, the method further comprises:
requesting the repeater or expecting the repeater to forward radio signals between a base station serving the repeater and at least one UE in the area; and
re-configuring the operating parameter of the base station serving the repeater.

13. The method according to claim 1, further comprising:
requesting the repeater to suspend forwarding radio signals between a base station serving the repeater and at least one UE in the area; and
requesting the hosting platform to stay in place or move to a new location and requesting the repeater to stand by.

14. The method of claim 1, further comprising:
receiving a hardware status indication from the repeater indicating that the repeater is unable to continue forwarding radio signals.

15. A network controller, comprising:
a memory, storing instructions; and
a processor coupled to the memory, configured to execute the instructions stored in the memory to perform the method of claim 1.

16. A movable device, comprising:
a repeater, configured to amplify and forward radio signals between a base station and at least one user equipment (UE) and;
a hosting platform, with the repeater mounted thereon, configured to receive from a network controller a network command conveying a target location determined for the repeater to move the repeater to the target location.

17. The movable device according to claim 16, wherein the repeater is operated based on at least one operating parameter provided by the network controller, and the at least one operating parameter comprises the target location and at least one of the following: orientation, altitude, antenna beam pattern, gain, and power of the repeater.

18. The movable device according to claim 16, wherein the hosting platform replies a current location, orientation and/or altitude to the network controller.

19. The movable device according to claim 16, wherein when the hosting platform cannot reach or maintain the target location as required by the network command, the hosting platform tries to get as close as possible to the target location.

20. The movable device according to claim 16, wherein when the hosting platform reaches the target location or a desired location, the repeater starts to forward the radio signals between the base station and the at least one UE.
